(19) United States
(12) Patent Application Publication
(10) Pub. No.: US 2025/0335032 A1
(43) Pub. Date: Oct. 30, 2025

(54) SOMATOSENSORY FEEDBACK METHOD AND SYSTEM AND NON-TRANSITORY COMPUTER READABLE STORAGE MEDIUM

(71) Applicant: HTC Corporation, Taoyuan City (TW)

(72) Inventors: Chang Hua WEI, Taoyuan City (TW); Yu-Ling HUANG, Taoyuan City (TW)

(21) Appl. No.: 18/650,120

(22) Filed: Apr. 30, 2024

(51) Int. Cl. G06F 3/01

(52) U.S. Cl. CPC G06F 3/016; G06F 3/011

(57) ABSTRACT

The present disclosure provides a somatosensory feedback method and system and a non-transitory computer readable storage medium. The somatosensory feedback method is applicable to a somatosensory feedback system, and includes: obtaining information of interaction between a target object in an immersive environment and a physical object operable by a user in a real-world environment according to sense data, wherein the information of interaction includes at least one of a relative position of the physical object with respect to the target object, a force applying direction of the physical object, a moving direction of the target object, and a number of the physical object interacting with the target object; and providing a vibration feedback for the physical object according to the information of interaction.

### BACKGROUND

### Field of Invention

This disclosure relates to a method and system, and in particular to a somatosensory feedback method and system.

### Description of Related Art

In the technical field of the virtual reality (VR), augmented reality (AR) and/or mixed reality (MR), when the user interacts with at least one virtual reality object, some related arts usually provide the feedback for the user, to ensure the user knows that the interaction is valid. However, these related arts normally do not consider the simulated characteristic (e.g., acceleration, weight, material, etc.) of the virtual reality object, and thus only provides the single-level vibration feedback for the user, which results in that the user has a bad experience or immersion. Therefore, it is important to propose a new approach for providing the feedback for the user.

### SUMMARY

An aspect of present disclosure relates to a somatosensory feedback method. The somatosensory feedback method is applicable to a somatosensory feedback system, and includes: obtaining information of interaction between a target object in an immersive environment and a physical object operable by a user in a real-world environment according to sense data, wherein the information of interaction includes at least one of a relative position of the physical object with respect to the target object, a force applying direction of the physical object, a moving direction of the target object, and a number of the physical object interacting with the target object; and providing a vibration feedback for the physical object according to the information of interaction.

Another aspect of present disclosure relates to a somatosensory feedback system. The somatosensory feedback system includes a vibrator, a sensor and a processor. The sensor is configured to generate sense data. The processor is coupled to the sensor and the vibrator, and configured to: obtain information of interaction between a target object in an immersive environment and a physical object operable by a user in a real-world environment according to the sense data, wherein the information of interaction includes at least one of a relative position of the physical object with respect to the target object, a force applying direction of the physical object, a moving direction of the target object, and a number of the physical object interacting with the target object; and control the vibrator according to the information of interaction, to provide a vibration feedback for the physical object.

Another aspect of present disclosure relates to a non-transitory computer readable storage medium with a computer program to execute a somatosensory feedback method, wherein the somatosensory feedback method is applicable to a somatosensory feedback system, and includes: obtaining information of interaction between a target object in an immersive environment and a physical object operable by a user in a real-world environment according to sense data, wherein the information of interaction includes at least one of a relative position of the physical object with respect to the target object, a force applying direction of the physical object, a moving direction of the target object, and a number of the physical object interacting with the target object; and providing a vibration feedback for the physical object according to the information of interaction.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a somatosensory feedback system in accordance with some embodiments of the present disclosure;

FIG. 2 is a flow diagram of a somatosensory feedback method in accordance with some embodiments of the present disclosure;

FIG. 3 is a schematic diagram of the somatosensory feedback system applied to a multi-device system in accordance with some embodiments of the present disclosure;

FIGS. 4A and 4B are schematic diagrams of the relative position of one peripheral device with respect to the target object in accordance with some embodiments of the present disclosure;

FIGS. 5A and 5B are schematic diagrams of the relative position of at least two peripheral devices with respect to the target object in accordance with some embodiments of the present disclosure;

FIGS. 6A and 6B are schematic diagrams of the relative position of at least one peripheral device with respect to the target object in accordance with some embodiments of the present disclosure; and

FIG. 7 is a schematic diagram of the somatosensory feedback system applied to another multi-device system in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

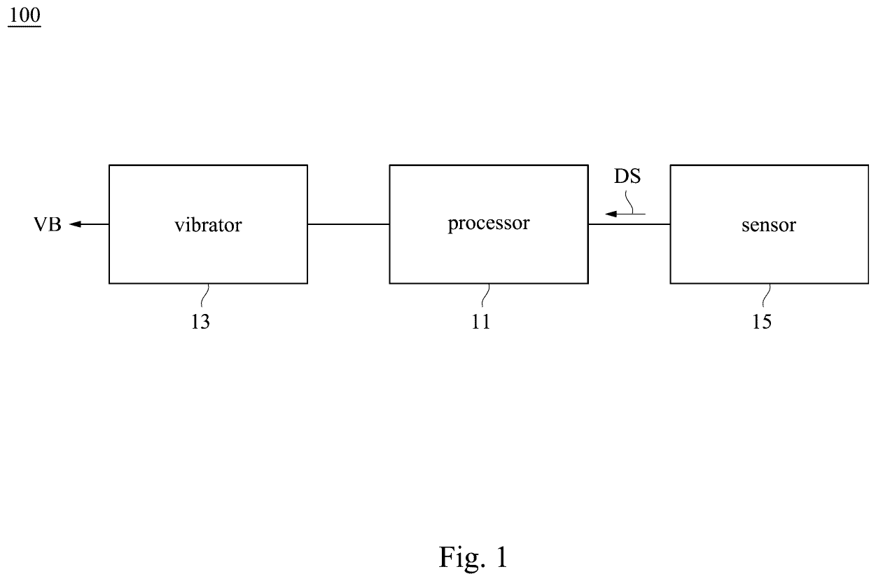

Referring to FIG. 1, FIG. 1 is a block diagram of a somatosensory feedback system 100 in accordance with some embodiments of the present disclosure. In some embodiments, the somatosensory feedback system 100 can be used to detect interaction of at least one real-world object with at least one virtual reality object, and to provide a vibration feedback VB for the at least one real-world object according to the interaction. By such arrangements, the somatosensory feedback system 100 can give an experience conforming with the physical laws to someone operating the at least one real-world object in a real-world environment (e.g., a gaming place, a private room, etc.).

For example, if someone hits a simulated tennis ball (i.e., the virtual reality object), which cannot be directly seen in the real-world environment, with an actual tennis racket (i.e., the real-world object), the somatosensory feedback system 100 can generate the vibration feedback VB on the actual tennis racket, which is substantially consistent with a vibration generated on the actual tennis racket when the actual tennis racket hits an actual tennis ball.

In some embodiments, as shown in FIG. 1, the somatosensory feedback system 100 includes a processor 11, a vibrator 13 and a sensor 15. In particular, the processor 11 is electrically and/or communicatively coupled to the sensor 15, and can receive and process sense data DS generated by the sensor 15, so as to detect the interaction of the at least one real-world object with the at least one virtual reality object. In addition, the processor 11 is electrically and/or communicatively coupled to the vibrator 13, and can control the vibrator 13 to vibrate according to the detected interaction, so that the somatosensory feedback system 100 can provide the vibration feedback VB corresponding to the detected interaction.

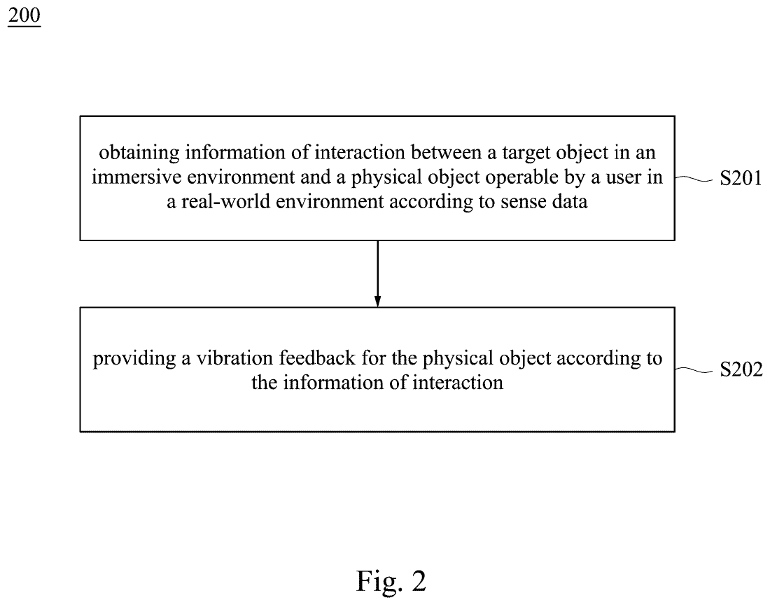

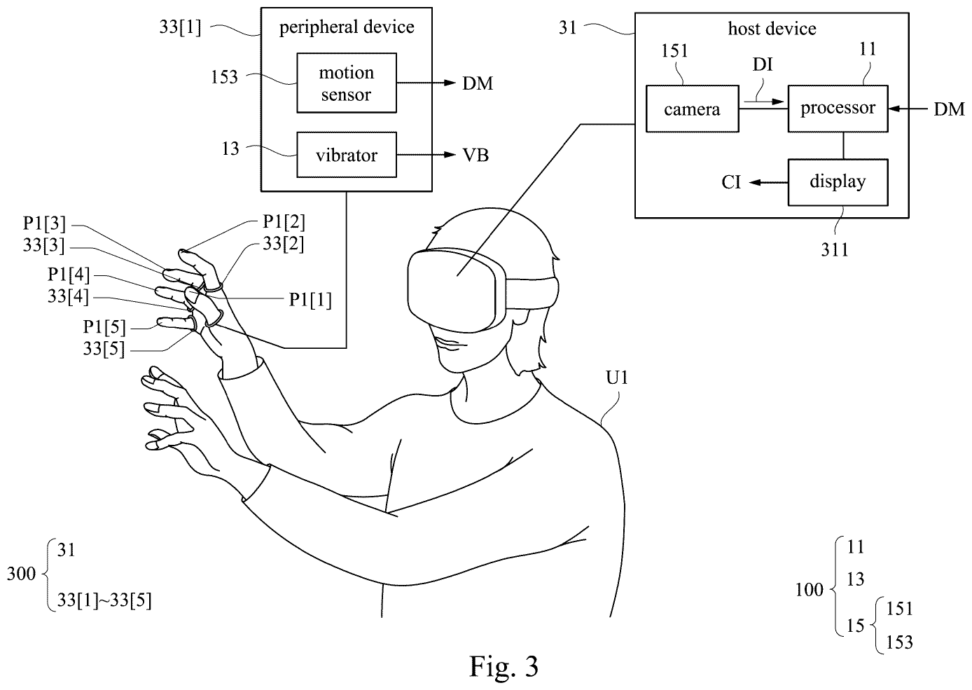

The operations of the somatosensory feedback system 100 would be described in detail with reference to FIGS. 2 and FIG. 3. FIG. 2 is a flow diagram of a somatosensory feedback method 200 applicable to the somatosensory feedback system 100 in accordance with some embodiments of the present disclosure. FIG. 3 is a schematic diagram of the somatosensory feedback system 100 applied to a multi-device system 300 in accordance with some embodiments of the present disclosure.

In some embodiments, as shown in FIG. 3, the multi-device system 300 can be operated by a user U1 in the real-world environment, and includes a host device 31 and multiple peripheral devices 33[1]-33[5]. In the following embodiments, if the reference character of component(s) is used without specifying its numerical index, it indicates that reference character of component(s) is referred to anyone in the group to which the component(s) belongs. For example, the peripheral device 33 is referred to anyone of the peripheral devices 33[1]-33[5].

In the embodiments of FIG. 3, the multi-device system 300 is implemented with an immersive system usually used to provide an immersive environment CI for the user U1. For example, the host device 31 is a head mounted device (HMD) of the immersive system, and is worn on the head of the user U1. Also, the peripheral device 33 can be a ring shaped controller of the immersive system, and is worn on any finger of the user U1.

In some embodiments, the host device 31 may occlude the direct visibility of the user U1 to the real-world environment. In this case, the immersive environment CI can be a virtual reality (VR) environment, or a mixed reality (MR) environment. In particular, the virtual reality environment may include the at least one virtual reality object, which cannot be directly seen in the real-world environment by the user U1. The mixed reality environment simulates the real-world environment and enables interaction of the at least one virtual reality object with a simulated real-world environment. However, the present disclosure is not limited herein. For example, the immersive environment CI can be a simulated real-world environment without other virtual reality objects, which is known as a pass-through view.

In some embodiments, the host device 31 does not occlude the direct visibility of the user U1 to the real-world environment. In this case, the immersive environment CI can be an augmented reality (AR) environment. In particular, the augmented reality environment augments the real-world environment directly seen by the user U1 with the at least one virtual reality object.

In accordance with the above embodiments that the immersive environment CI is the virtual reality environment, the mixed reality environment or the augmented reality environment, the user U1 can control the at least one virtual reality object in the immersive environment CI with the peripheral devices 33[1]-33[5] as shown in FIG. 3.

In some further embodiments, as shown in FIG. 3, the sensor 15 of the somatosensory feedback system 100 includes a camera 151 and a motion sensor 153. The camera 151 and the processor 11 of the somatosensory feedback system 100 are integrated to the host device 31 of the multi-device system 300, and the processor 11 is electrically coupled to both the camera 151 and a display 311 of the host device 31. It should be understood that when the user U1 wears the host device 31, the processor 11 can control the display 311 to display, so as to provide the immersive environment CI for the user U1.

In addition, as shown in FIG. 3 again, the motion sensor 153 and the vibrator 13 of the somatosensory feedback system 100 are integrated to the peripheral device 33[1] of the multi-device system 300. In particular, the motion sensor 153 and the vibrator 13 may be electrically coupled to processing unit(s) and/or communicator(s) inherent in the peripheral device 33[1], so that the motion sensor 153 and the vibrator 13 can be communicatively coupled to the processor 11. It should be understood that other peripheral devices 33[2]-33[5] have the same structure as the peripheral device 33[1], and thus the peripheral devices 33[2]-33[5] would not be described again herein.

Referring to FIGS. 2 again, in operation S201, the processor 11 obtains information of interaction between a target object T1 in the immersive environment CI and a physical object P1 operable by the user U1 in the real-world environment according to the sense data DS. In some embodiments, as shown in FIG. 3, one of five fingers of the user U1 is referred to as the physical object P1. For example, the physical object P1[1] is a thumb of the user U1, the physical object P1[2] is an index finger of the user U1, the physical object P1[3] is a middle finger of the user U1, the physical object P1[4] is a ring finger of the user U1, and the physical object P1[5] is a little finger of the user U1. In addition, the target object T1 can be a virtual reality ball, and the user U1 can grip and move the virtual reality ball in the immersive environment CI by the hand wearing the peripheral devices 33[1]-33[5].

In some embodiments, the camera 151 captures images of the hand wearing the peripheral devices 33[1]-33[5], and generates image data DI (as shown in FIG. 3) related to the physical object P1 as the sense data DS of FIG. 1 to the processor 11. Accordingly, in some embodiments of operation S201, the processor 11 can use at least one existing computer vision-based image recognition technology to analyze the image data DI. By the computer vision-based image recognition technology, the processor 11 detects multiple key points, which can be corresponding to multiple landmarks (e.g., fingertip, joint, etc.) of the physical objects P1[1]-P1[5] of FIG. 3, in the image data DI, and estimates the position of each key point in a predefined spatial system whose origin is associated with the position of the host device 31 in the real-world environment. Thus, the processor 11 can infer pose data of the physical objects P1[1]-P1[5] from the position of each key point. In brief, the processor 11 calculates the pose data of the physical object P1 from the sense data DS.

In accordance with the above embodiments, the processor 11 can access pose data of the target object T1 (which can be stored in a storage (not shown) of the host device 31). Then, the processor 11 uses the pose data of the physical object P1 and the pose data of the target object T1 to determine the relative position of the physical object P1 with respect to the target object T1. It can be seen from the above descriptions that the processor 11 determines the relative position of the physical object P1 with respect to the target object T1 by using the sense data DS (e.g., the image data DI).

It should be understood that the relative position of the physical object P1 with respect to the target object T1 is not limited to be determined by using the image data DI. Referring to FIG. 3 again, in some embodiments, the motion sensor 153 sense the movement of the peripheral device 33 (which is induced by the movement of the physical object P1) to generate motion data DM related to the peripheral device 33 as the sense data DS of FIG. 1 to the processor 11. In particular, the motion sensor 153 can be implemented with an inertial measurement unit (IMU) including an accelerometer, a gyroscope and a magnetometer, and the motion data DM include acceleration data and angular velocity data correspondingly. Accordingly, in some embodiments of operation S201, the processor 11 can then perform mathematical operation(s) (e.g., orthogonal decomposition, integration, etc.) on the motion data DM to calculate pose data of the peripheral device 33.

In accordance with the above embodiments, because the peripheral device 33 is usually worn on the part of the finger where the palm connects only, the pose data of the peripheral device 33 cannot represent the pose of the finger directly. Thus, in some embodiments of operation S201, the processor 11 further transforms the pose data of the peripheral device 33 by preset transformation data, to generate the pose data of the physical object P1. Notably, the preset transformation data can be set according to the user U1's perception of touching the target object T1 with one specific part of the finger. For example, when the user U1 has the perception that the target object T1 should be touched by the fingertip, the preset transformation data can be set to be corresponding to an average length of the finger. In such arrangements, the processor 11 can also use the pose data of the physical object P1 and the pose data of the target object T1 to determine the relative position of the physical object P1 with respect to the target object T1.

As can be seen from the above descriptions, in some embodiments, the sensor 15 of the somatosensory feedback system 100 can include at least one of the camera 151 and the motion sensor 153 to generate the sense data DS to the processor 11.

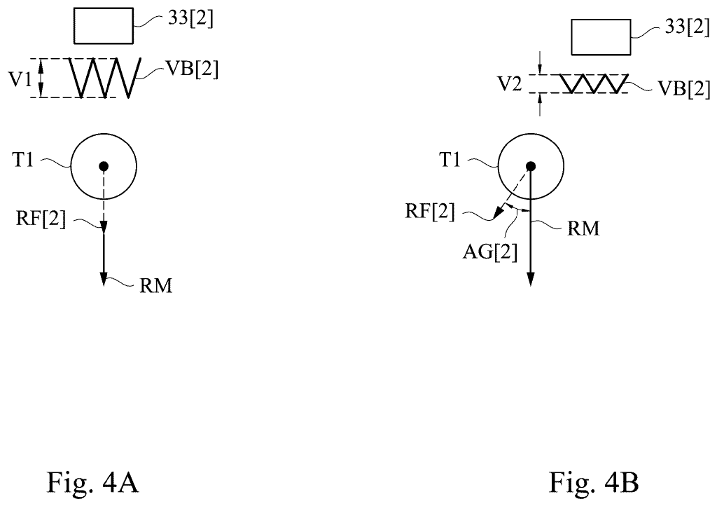

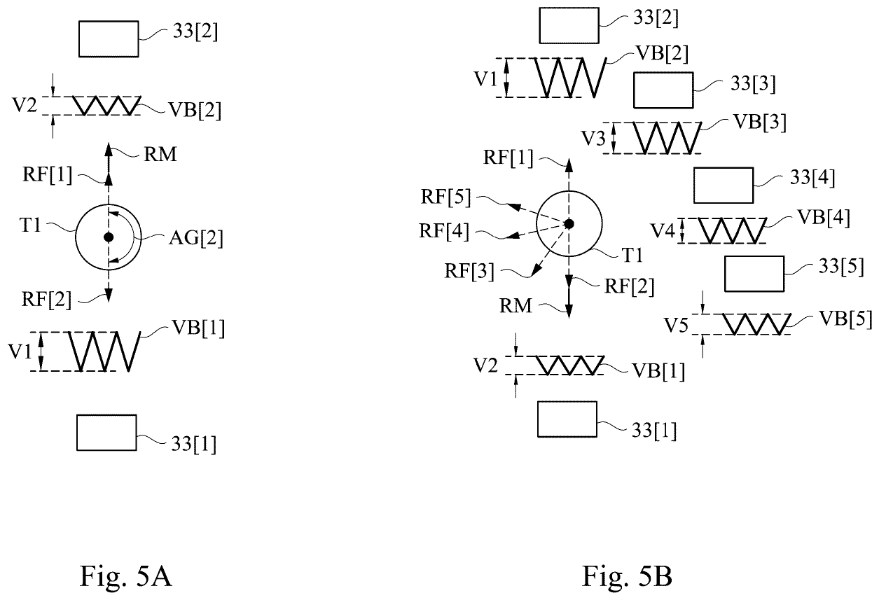

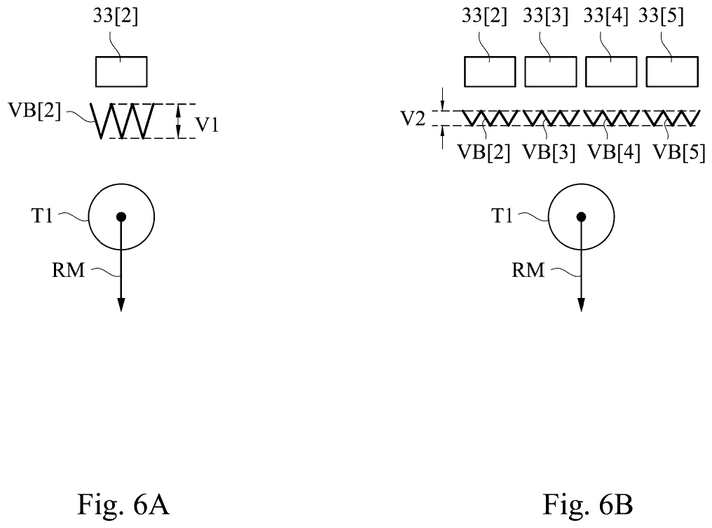

The relative position of the physical object P1 with respect to the target object T1 can be further utilized, which would be described with reference to FIGS. 4A-4B, 5A-5B and 6A-6B. FIGS. 4A and 4B are schematic diagrams of the relative position of the peripheral device 33[2] with respect to the target object T1 in accordance with some embodiments of the present disclosure. FIG. 5A is a schematic diagram of the relative position of the peripheral devices 33[1]-33[2] with respect to the target object T1 in accordance with some embodiments of the present disclosure. FIG. 5B is a schematic diagram of the relative position of the peripheral devices 33[1]-33[5] with respect to the target object T1 in accordance with some embodiments of the present disclosure. FIG. 6A is a schematic diagram of the relative position of the peripheral device 33[2] with respect to the target object T1 in accordance with some embodiments of the present disclosure. FIG. 6B is a schematic diagram of the relative position of the peripheral devices 33[2]-33[5] with respect to the target object T1 in accordance with some embodiments of the present disclosure. In FIGS. 4A-4B, 5A-5B and 6A-6B, the peripheral device 33 (which is worn on the corresponding physical object P1 in FIG. 3) is used to represent the corresponding physical object P1, so as to present the relative position of the corresponding physical object P1 with respect to the target object T1.

Normally, when the user U1 grips an actual ball, the user U1 will apply the force towards the actual ball with the fingers. Thus, in some embodiments, as shown in FIGS. 4A and 4B, the processor 11 uses a direction in which the physical object P1[2] (which wears the peripheral device 33[2]) approaches towards the target object T1 as a force applying direction RF[2] of the physical object P1[2]. It should be understood that the force applying direction RF[1] of the physical object P1[1], the force applying direction RF[3] of the physical object P1[3], the force applying direction RF[4] of the physical object P1[4] and the force applying direction RF[5] of the physical object P1[5] in FIGS. 5A and 5B can be deduced by analogy.

Also, the position of the target object T1 in the immersive environment CI may change in response to the interaction of the physical object P1 with the target object T1. Accordingly, in the embodiments, as shown in FIGS. 4A-4B, 5A-5B and 6A-6B, the processor 11 can infer a moving direction RM of the target object T1 based on the position of the target object T1 and the pose data of the physical object P1.

Based on the descriptions of the force applying direction RF and the moving direction RM, in some embodiments of operation S201, the processor 11 determines the force applying direction RF of the physical object P1 and the moving direction RM of the target object T1 according to the relative position of the physical object P1 with respect to the target object T1.

Furthermore, the relative position of the physical object P1 with respect to the target object T1 is not limited to be used to determine the force applying direction RF and the moving direction RM. For example, in some embodiments of operation S201, the processor 11 can determine whether the pose data of the physical object P1 is substantially the same as the pose data of the target object T1 (that is, the difference between the pose data of the physical object P1 and the pose data of the target object T1 is smaller than a preset threshold), so as to determine a number of the physical object P1 interacting with the target object T1.

In the embodiments of FIG. 6A, only the pose data of the physical object P1[2] is substantially the same as the pose data of the target object T1, which means that the user U1 has the perception that the target object T1 should be touched by the physical object P1[2]. In this case, the processor 11 determines the number of the physical object P1 interacting with the target object T1 is 1. In the embodiments of FIG. 6B, the pose data of the physical object P1[2], the pose data of the physical object P1[3], the pose data of the physical object P1[4] and the pose data of the physical object P1[5] are all substantially the same as the pose data of the target object T1, which means that the user U1 has the perception that the target object T1 should be touched by the physical objects P1[2]-P1[5]. In this case, the processor 11 determines the number of the physical object P1 interacting with the target object T1 is 4.

As can be seen from the descriptions of operation S201, the information of interaction can include at least one of the relative position of the physical object P1 with respect to the target object T1, the force applying direction RF of the physical object P1, the moving direction RM of the target object T1 and the number of the physical object P1 interacting with the target object T1.

Referring to FIG. 2 again, in operation S202, the somatosensory feedback system 100 provides the vibration feedback VB for the physical object P1 according to the information of interaction. In particular, referring to FIG. 3 again, the processor 11 can communicate with the peripheral device 33, and can further control the vibrator 13 in the peripheral device 33 according to the information of interaction, to provide the vibration feedback VB for the physical object P1.

In some further embodiments of operation S202, the processor 11 determines a strength of the vibration feedback VB according to an angle AG between the force applying direction RF of the physical object P1 and the moving direction RM of the target object T1. The angle AG can be referred to as the information of interaction. For example, in FIG. 4A, when the angle AG between the force applying direction RF[2] and the moving direction RM is substantially 0 degree, the strength of the vibration feedback VB[2] (which is provided by the vibrator 13 in the peripheral device 33[2]) is determined to be at a level V1. Also, in FIG. 4B, when the angle AG[2] between the force applying direction RF[2] and the moving direction RM is between 0 degree and 90 degrees (e.g., 30 degrees), the strength of the vibration feedback VB[2] is determined to be at a level V2. Notably, the level V2 is smaller than the level V1, which is set to simulate the physical law that the physical object P1[2] experiences a great resistance when the force applying direction RF[2] and the moving direction RM are similar. In conclusion, the greater the strength of the vibration feedback VB is, the smaller the angle AG is.

The conclusion of the embodiments of FIGS. 4A and 4B is applicable to the embodiments of FIGS. 5A and 5B. In FIG. 5A, the angle AG (e.g., 0 degree) between the force applying direction RF[1] and the moving direction RM is smaller than the angle AG[2] (e.g., 180 degrees) between the force applying direction RF[2] and the moving direction RM. In this case, the strength of the vibration feedback VB[1] is determined to be at the level V1, and the strength of the vibration feedback VB[2] is determined to be at the level V2.

Also, in the embodiments of FIG. 5B, the angle AG between the force applying direction RF[1] and the moving direction RM is the greatest angle (e.g., 180 degrees), the angle AG between the force applying direction RF[5] and the moving direction RM is a second greatest angle (e.g., an angle between 90 degrees and 180 degrees), the angle AG between the force applying direction RF[4] and the moving direction RM is a third greatest angle (e.g., an angle between 45 degrees and 90 degrees), the angle AG between the force applying direction RF[3] and the moving direction RM is a fourth greatest angle (e.g., an angle between 0 degree and 45 degrees), and the angle AG between the force applying direction RF[2] and the moving direction RM is the smallest angle (e.g., 0 degree). In this case, the strength of the vibration feedback VB[2] is determined to be at the level V1, the strength of the vibration feedback VB[3] is determined to be at a level V3, the strength of the vibration feedback VB[4] is determined to be at a level V4, the strength of the vibration feedback VB[5] is determined to be at a level V5, and the strength of the vibration feedback VB[1] is determined to be at the level V2. In particular, the level V3 is smaller than the level V1, the level V4 is smaller than the level V3, the level V5 is smaller than the level V4, and the level V2 is smaller than the level V5.

In some further embodiments of operation S202, the processor 11 determines the strength of the vibration feedback VB according to the number of the physical object P1 interacting with the target object T1 (i.e., the information of interaction). For example, in FIG. 6A, when the number of the physical object P1 interacting with the target object T1 is 1, the strength of the vibration feedback VB[2] (which is provided by the vibrator 13 in the peripheral device 33[2]) is determined to be at the level V1. Also, in FIG. 6B, when the number of the physical object P1 interacting with the target object T1 is 4, the strengths of the vibration feedbacks VB[2]-VB[5] are determined to be at the level V2. In conclusion, the greater the strength of the vibration feedback VB is, the less the number of the physical object P1 interacting with the target object T1 is, which is set to simulate the physical law that the hand experiences a great resistance when moving the actual ball with a smaller number of the fingers.

Based on the descriptions of operations S201-S202, it can be seen that operation S202 may by executed in response to the detection of interaction between the target object T1 in the immersive environment CI and the physical object P1 operable by the user U1 in the real-world environment. For example, operation S202 may by executed when the user U1 has the perception of touching the target object T1 in the immersive environment CI.

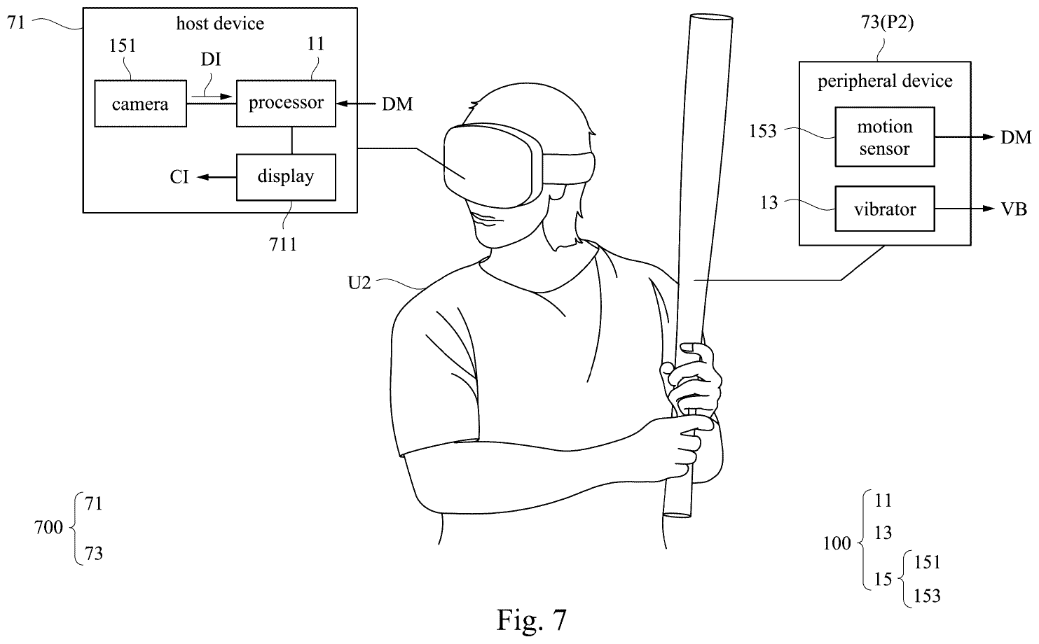

It should be understood that the application of the somatosensory feedback system 100 is not limited to that shown in FIG. 3. Referring to FIG. 7, FIG. 7 is a schematic diagram of the somatosensory feedback system 100 applied to another multi-device system 700 in accordance with some embodiments of the present disclosure. The multi-device system 700 can be operated by another user U2 in the real-world environment, and includes a host device 71 and a peripheral device 73. In particular, the multi-device system 700 is also implemented with an immersive system. The host device 71 is also a head mounted device of the immersive system, and includes a display 711 to provide the immersive environment CI for the user U2. Also, the peripheral device 73 can be a baseball bat shaped controller of the immersive system, and is hold by the user U2 to interact with the at least one virtual reality object in the immersive environment CI.

In the embodiments of FIG. 7, the camera 151 of the sensor 15 and the processor 11 are integrated to the host device 71, and the processor 11 is electrically coupled to both the camera 151 and the display 711. The motion sensor 153 of the sensor 15 and the vibrator 13 are integrated to the peripheral device 73, and the processor 11 is communicatively coupled to both the motion sensor 153 and the vibrator 13.

As shown in FIG. 7, the peripheral device 73 is referred to as a physical object P2 in these embodiments. In some embodiments of operation S201, the processor 11 can obtain the information of interaction between the target object T1 in the immersive environment CI and the physical object P2 operable by the user U2 in the real-world environment with the image data DI generated by the camera 151 and/or the motion data DM generated by the motion sensor 153. In particular, the camera 151 captures images of the physical object P2 hold by the user U2, and generates the image data DI related to the physical object P2. Also, the motion sensor 153 sense the movement of the physical object P2 to generate the motion data DM related to the physical object P2. In addition, in some embodiments of operation S202, the processor 11 can control the vibrator 13 according to the information of interaction (e.g., a relative position of the physical object P2 with respect to the target object T1), to provide the vibration feedback VB for the physical object P2. The operations of the processor 11, the camera 151 and the motion sensor 153 in FIG. 7 are similar to those in FIG. 3, and therefore are simplified herein.

As can be seen from the above embodiments of the present disclosure, by obtaining the information of interaction between the target object T1 in the immersive environment CI and the physical object P1/P2 (i.e., the fingers in FIG. 3, the baseball bat shaped controller in FIG. 7, etc.) operable by the user U1/U2 in the real-world environment, the somatosensory feedback system 100 and the somatosensory feedback method 200 of the present disclosure can generate the vibration feedback VB, which is substantially consistent with the intuitive perception of the user U1/U2, for the physical object P1/P2. In sum, the somatosensory feedback system 100 and the somatosensory feedback method 200 have advantages of enhancing the user's immersion in the immersive environment, etc.

In the above embodiments, the processor 11 can be implemented with a central processing unit (CPU), an application-specific integrated circuit (ASIC), a microprocessor, a system on a Chip (SoC) or other suitable processing circuits. The display 311 or the display 711 can be implemented with an active matrix organic light emitting diode (AMOLED) display, organic light emitting diode (OLED) display, or other suitable displays.

It should be understood that the applications of the somatosensory feedback system 100 is not limited to that shown in FIG. 3 or 7. For example, in some embodiments, the processor 11 can be independent from the host device 31/71, and can wirelessly communicate with processing unit(s) inherent in the host device 31/71, to further communicate with the camera 151 and the display 311/711. Also, in some embodiments, the camera 151 can be independent from the host device 31/71, and can wirelessly communicate with the processor 11 in the host device 31/71.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A somatosensory feedback method, applicable to a somatosensory feedback system, and comprising:
obtaining information of interaction between a target object in an immersive environment and a physical object operable by a user in a real-world environment according to sense data, wherein the information of interaction comprises at least one of a relative position of the physical object with respect to the target object, a force applying direction of the physical object, a moving direction of the target object, and a number of the physical object interacting with the target object; and
providing a vibration feedback for the physical object according to the information of interaction.

2. The somatosensory feedback method of claim 1, wherein obtaining the information of interaction between the target object and the physical object comprises:
determining the relative position of the physical object with respect to the target object by using the sense data; and
determining the force applying direction of the physical object and the moving direction of the target object according to the relative position.

3. The somatosensory feedback method of claim 2, wherein determining the relative position of the physical object with respect to the target object by using the sense data comprises:
calculating pose data of the physical object from the sense data; and
using the pose data of the physical object and pose data of the target object to determine the relative position of the physical object with respect to the target object.

4. The somatosensory feedback method of claim 1, wherein obtaining the information of interaction between the target object and the physical object comprises:
determining the relative position of the physical object with respect to the target object by using the sense data; and
determining the number of the physical object interacting with the target object according to the relative position.

5. The somatosensory feedback method of claim 2, wherein determining the relative position of the physical object with respect to the target object by using the sense data comprises:
calculating pose data of a peripheral device of a multi-device system, which is arranged on the physical object, from the sense data;
transforming the pose data of the peripheral device by preset transformation data, to generate pose data of the physical object; and
using the pose data of the physical object and pose data of the target object to determine the relative position of the physical object with respect to the target object.

6. The somatosensory feedback method of claim 1, wherein providing the vibration feedback for the physical object according to the information of interaction comprises:
determining a strength of the vibration feedback according to the number of the physical object interacting with the target object, wherein the greater the strength of the vibration feedback is, the less the number is.

7. The somatosensory feedback method of claim 1, wherein providing the vibration feedback for the physical object according to the information of interaction comprises:
determining a strength of the vibration feedback according to an angle between the force applying direction of the physical object and the moving direction of the target object, wherein the greater the strength of the vibration feedback is, the smaller the angle is.

8. The somatosensory feedback method of claim 1, further comprising:
by a motion sensor of the somatosensory feedback system, generating motion data related to a peripheral device of a multi-device system, which is arranged on the physical object, as the sense data.

9. The somatosensory feedback method of claim 1, further comprising:
by a motion sensor of the somatosensory feedback system, generating motion data related to the physical object as the sense data.

10. The somatosensory feedback method of claim 1, further comprising:
by a camera of the somatosensory feedback system, generating image data related to the physical object as the sense data.

11. A somatosensory feedback system, comprising:
a vibrator;
a sensor, configured to generate sense data; and
a processor, coupled to the sensor and the vibrator, and configured to:
obtain information of interaction between a target object in an immersive environment and a physical object operable by a user in a real-world environment according to the sense data, wherein the information of interaction comprises at least one of a relative position of the physical object with respect to the target object, a force applying direction of the physical object, a moving direction of the target object, and a number of the physical object interacting with the target object; and
control the vibrator according to the information of interaction, to provide a vibration feedback for the physical object.

12. The somatosensory feedback system of claim 11, wherein the processor is configured to:
determine the relative position of the physical object with respect to the target object by using the sense data; and
determine the force applying direction of the physical object and the moving direction of the target object according to the relative position.

13. The somatosensory feedback system of claim 12, wherein the processor is configured to:
calculate pose data of the physical object from the sense data; and
use the pose data of the physical object and pose data of the target object to determine the relative position of the physical object with respect to the target object.

14. The somatosensory feedback system of claim 11, wherein the processor is configured to:
determine the relative position of the physical object with respect to the target object by using the sense data; and
determine the number of the physical object interacting with the target object according to the relative position.

15. The somatosensory feedback system of claim 14, wherein the processor is configured to:
calculate pose data of a peripheral device of a multi-device system, which is arranged on the physical object, from the sense data;
transform the pose data of the peripheral device by preset transformation data, to generate pose data of the physical object; and
use the pose data of the physical object and pose data of the target object to determine the relative position of the physical object with respect to the target object.

16. The somatosensory feedback system of claim 11, wherein the processor is configured to:
determine a strength of the vibration feedback according to the number of the physical object interacting with the target object, wherein the greater the strength of the vibration feedback is, the less the number is.

17. The somatosensory feedback system of claim 11, wherein the processor is configured to:
determine a strength of the vibration feedback according to an angle between the force applying direction of the physical object and the moving direction of the target object, wherein the greater the strength of the vibration feedback is, the smaller the angle is.

18. The somatosensory feedback system of claim 11, wherein the sensor comprises a motion sensor, and the motion sensor is configured to generate motion data related to a peripheral device of a multi-device system, which is arranged on the physical object, as the sense data.

19. The somatosensory feedback system of claim 11, wherein the sensor comprises a camera, and the camera is configured to generate image data related to the physical object as the sense data.

20. A non-transitory computer readable storage medium with a computer program to execute a somatosensory feedback method, wherein the somatosensory feedback method is applicable to a somatosensory feedback system, and comprises:
obtaining information of interaction between a target object in an immersive environment and a physical object operable by a user in a real-world environment according to sense data, wherein the information of interaction comprises at least one of a relative position of the physical object with respect to the target object, a force applying direction of the physical object, a moving direction of the target object, and a number of the physical object interacting with the target object; and
providing a vibration feedback for the physical object according to the information of interaction.
